(19) United States
(12) Patent Application Publication
(10) Pub. No.: US 2016/0196708 A1
(43) Pub. Date: Jul. 7, 2016

(54) METHODS AND SYSTEMS FOR SORTING BANK NOTES, PROVIDING A CHANGE FUND, AND BALANCING REVENUE

(71) Applicant: Glory Limited, Himeji (JP)

(72) Inventors: Kazuhiro Doi, Himeji (JP); Hirofumi Ozaki, Tokyo (JP); Osamu Ito, Kawaguchi (JP); Sadaaki Uesaka, Fukusaki (JP)

(21) Appl. No.: 15/017,304

(22) Filed: Feb. 5, 2016

Related U.S. Application Data
(63) Continuation of application No. 12/762,164, filed on Apr. 16, 2010, now abandoned.
Application No. 12/762,164 is a division of application No. 12/015,684, filed on Jan. 17, 2008, now abandoned.

(51) Int. Cl. G07D 11/00; G06Q 20/20; G06Q 20/10

(52) U.S. Cl. CPC G07D 11/0054; G07D 11/0084; G06Q 20/1085; G06Q 20/20

(57) ABSTRACT

A method is provided for sorting bank notes using a bank note processing apparatus having an at least one input receptacle, at least one identification unit, and a plurality of stacker units. The method includes receiving the bank notes in the input receptacle or receptacles. The bank notes are identified when passed through or by the identification unit or units. The bank notes are sorted into the plurality of stacker units according to the results of the identification, which includes stacking each of one or more change funds into at least one stacker unit and stacking the remaining bank notes into at least one stacker unit. Each change fund includes a predetermined value and two or more predetermined denominations.

### CROSS-REFERENCE TO RELATED APPLICATIONS

This application is a continuation of U.S. patent application Ser. No. 12/762,164, filed on Apr. 16, 2010, which is a divisional of U.S. patent application Ser. No. 12/015,684, filed on Jan. 17, 2008, the entire content of each of which is incorporated herein by reference.

### FIELD OF THE INVENTION

The present invention relates to processing of bank notes, and more particularly, to methods and apparatuses for sorting bank notes to provide a change fund, and to methods and systems for balancing revenue collected at a cash collection point and aiding in the process of opening and closing a cash collection point.

### BACKGROUND OF THE INVENTION

In retail venues, such as in supermarkets, fast food restaurants, and the like, as well as non-retail venues where cash is used for purchases, fee collection, banking transactions, and the like, customers make transactions at a point-of-sale (POS). For example, the POS can be a cash register that is operated by a cashier. The POS can also be a self-checkout system, a toll booth, a bank terminal, a cash drawer, or any other system where cash transactions take place. Typically, these venues perform a revenue balancing process at the end of a business day or at the end of a work shift to reconcile and balance cash received by the POS with sales data received from the POS.

At the start of a business day or at the beginning of a work shift, a cash drawer is typically inserted into a POS by a cashier or other attendant. The cash drawer typically contains an initial change fund that typically includes a number of coins and bank notes of specific denominations totaling to a predetermined value. The change fund is used to make change for customer transactions throughout the work shift or business day. The POS records sales data from each of the customer transactions. The sales proceeds from the customer transactions made at the POS are collected in the cash drawer and are co-mingled with the change fund.

At the close of the business day or the end of the work shift, the cash drawer is taken from the POS. The bank notes and coins are removed from the change drawer and counted either by hand or by a conventional bank note or coin counting machine. The remaining checks, coupons, and other non-bank note documents are also counted. The total value of the bank notes, coins, checks, and other non-bank note documents is verified against the added value of the sales revenue recorded by the POS plus the initial change fund.

In some venues, all of the counted bank notes, coins, and checks are stored in a safe with the rest of the day's proceeds until being taken to the bank by armored car to be deposited. An armored car will return with a new supply of money at the beginning of the next business day. The new supply of money, which is to be used for the initial change funds for each cash register constituting the POS, may either be pre-separated into individual initial change funds by the bank or must be prepared by an employee. If separated by an employee, the individual initial change funds are prepared by hand or by running the bank notes through a conventional bank note counting machine.

In other venues, after the bank notes are counted, initial change funds may be separated from the proceeds before sending the day's proceeds to be deposited in the bank. The bank notes in the initial change funds may be separated by hand or by running the bank notes through a conventional bank note processing machine. Each of the initial change funds are then placed back into the POS cash drawers, which are then stored in a storage safe for subsequent use or given to a cashier to use during his/her work shift.

Counting the bank notes and separating the initial change funds from the sales proceeds by hand has numerous drawbacks. Most of all, it increases the time and responsibility placed upon the employees and increases the possibility that the initial change funds are miscalculated, resulting in a shortage or overage in the sales proceeds deposited in the bank.

Conventional bank note counting machines are used to increase efficiency in the bank note counting process. Bank note counting machines typically count all of the bank notes input into the machines. Some bank note counting machines may be configured to set a strap limit for the total number of bank notes counted so that a certain number of bank notes are bundled together. Other bank note counting machines may be configured to set a strap limit for a number of bank notes for each specific denomination, stopping once the strap limit for each of the denominations is reached.

However, conventional bank note counting machines are not designed to simultaneously count all of the bank notes and to separate out the bank notes designated for initial change funds from the bank notes designated for the sales proceeds. For example, the bank notes must typically be passed through a bank note counting machine once for counting all of the bank notes and again for separating out bank notes for the initial change funds, which increases processing time. Thus, it is either necessary to configure the settings of the bank note counting machine each time it is switched between the different counting or separating processes, or to have separate bank note counting machines for counting the bank notes and for separating out the initial change funds.

### SUMMARY OF THE INVENTION

According to one embodiment of the present invention, a method is provided for automatically sorting bank notes using a bank note processing apparatus having at least one input receptacle, at least one identification unit, and a plurality of stacker units. The method includes receiving the bank notes in the input receptacle or receptacles. The bank notes are identified when passed through or by the identification unit or units. The value of the bank notes is determined. The bank notes are sorted into the plurality of stacker units according to the results of the identification, which includes stacking each of one or more change funds into at least one stacker unit and stacking the remaining bank notes into at least one stacker unit. Each change fund includes a predetermined number or value of bank notes of different denominations.

According to one embodiment of the present invention, a system is provided for sorting bank notes. The system includes at least one input receptacle on which bank notes are placed. A conveyance transports the bank notes from the input receptacle in a one by one fashion along a transport path. At least one bank note identification unit identifies the bank notes. A sorting mechanism sorts the bank notes into one of a plurality of stacker units according to the results of the identification. A controller controls the conveyance, the bank note identification unit, and the sorter to determine the value of the bank notes, stack each of one or more change funds into a stacker unit, and stack the remaining bank notes into at least one stacker unit. Each change fund includes a predetermined number or value of bank notes of different denominations.

According to one embodiment, a method is provided for dynamically adjusting a change fund for a point-of-sale based upon transaction data recorded by the point-of-sale. The change fund has a predetermined value of bank notes of different denominations and is processed by a bank note processing apparatus. The method includes receiving the transaction data recorded by the point-of-sale. The value for the change fund is determined from the recorded transaction data. The value of bank notes collected from the point-of-sale is determined. The change fund is separated out from the collected bank notes.

According to one embodiment, a system is provided for dynamically adjusting a change fund having a predetermined number or value of bank notes of different denominations. The system includes at least one point-of-sale for collecting sales proceeds from transactions and recording transaction data. A bank note counter determines the value the bank notes collected from the point-of-sale, sorts the bank notes, and separates out the change fund for at least one point-of-sale from the collected bank notes. A cash settlement terminal, which is coupled to the point-of-sale and the bank note counter, receives the recorded transaction data and determines the value of the change fund based on the recorded transaction data.

According to one embodiment of the present invention, a method is provided for balancing revenue using a point-of-sale and a bank note processing apparatus. The point-of-sale initially contains an initial change fund including at least bank notes. The method includes receiving transaction data which is recorded by the point-of-sale, which includes sales revenue. The value of sales proceeds collected in the point-of-sale, including the bank notes collected therein, is determined. The recorded sales revenue is compared to the determined sales proceeds. To determine the value of the bank notes collected in the point-of-sale, the bank note processing apparatus receives the bank notes in an input receptacle and identifies the bank notes when passed through or by an identification unit. The bank notes are sorted into a plurality of stacker units of the bank note processing apparatus according to the results of the identification. The sorting of the bank notes includes stacking a change fund into at least one stacker unit and the remaining bank notes into at least one stacker unit. The change fund includes a predetermined number or value of bank notes of different denominations.

According to one embodiment of the present invention, a system for balancing revenue is provided. The system includes a point-of-sale, a cash settlement terminal coupled to the point-of-sale, and a bank note counter coupled to the cash settlement terminal. The point-of-sale initially contains an initial change fund including at least bank notes. The point-of-sale collects sales proceeds from transactions and records sales revenue from the transactions. The cash settlement terminal receives the recorded sales revenue from the point-of sale. The bank note counter determines the value of the bank notes, sorts the bank notes, separates out a change fund having a predetermined number or value of bank notes of different denominations, and transmits the determined value of the bank notes to the cash settlement terminal. The cash settlement terminal performs a comparison between the recorded sales revenue and sales proceeds collected in the point-of-sale, using the determined value of the bank notes.

In each of the foregoing embodiments, many variations on the number and type of stacker units are possible. There can be one stacker unit for each denomination, or fewer stacker units. Bank notes of the change fund destined to be returned to the change drawer of a POS can be separated by using one or more stacker units. Rejects and the remaining bank notes can each be separated using one or more stacker units. The bank notes of the change fund can be offset within the same stacker unit or units used for receiving other bank notes by an offsetting apparatus that operates similarly to those used in existing copy machines to offset different documents or copies. A slip sheet can be inserted in a stacker unit after the predetermined quantity of bank notes for a change fund has been met. The stacker units (or other mechanisms in the system) can be configured to bind or strap funds as well. It is also possible to configure the input receptacle or the output stackers to accommodate and/or be used with the change drawer itself.

These and other features of this invention are described in, or are apparent from, the following detailed description of various exemplary embodiments of this invention.

### BRIEF DESCRIPTION OF THE DRAWINGS

Exemplary embodiments of this invention will be described with reference to the accompanying figures.

FIGS. 1-6 are front elevational views in longitudinal cross section of exemplary bank note processing apparatuses.

FIG. 6A illustrates a cash box removed from the exemplary bank note processing apparatus of FIG. 6.

FIG. 7 is a block diagram showing an exemplary internal arrangement of a bank note processing apparatus.

FIG. 8 is a flowchart illustrating a method of sorting bank notes according to one embodiment of the present invention.

FIG. 9 is a block diagram/flow chart of a system for providing a change fund according to one embodiment of the present invention.

FIG. 10 is a block diagram/flow chart of a system for managing revenue according to one embodiment of the present invention.

### DETAILED DESCRIPTION OF THE EXEMPLARY EMBODIMENTS

As used herein, a “bank note” refers to either a U.S. or foreign bank note. A “U.S. bank note” refers to U.S. legal tender, such as a $1, $2, $5, $10, $20, $50, or $100 note, and a “foreign bank note” refers to any bank note issued by a non-U.S. governmental agency as legal tender, such as a Euro, Japanese Yen, or British Pound note. The terms “currency note” and “currency bill” are synonymous with the term “bank note.”

As used herein, a “reject” is a document that is identified as an invalid bank note or that is unidentifiable by a bank note processing apparatus. For example, rejects may include bank notes that are skewed, bent, folded, torn, and/or defaced. Further, rejects may include selected or unselected denominations of bank notes and/or foreign bank notes not specified for use with a particular bank note processing apparatus, as well as other non-bank note documents, such as counterfeit currency, blank paper, coupons, checks, etc. Counterfeit bills can be treated the same as other rejected bills, can be assigned different output locations in the bank note processing apparatus or can undergo different processing, such as stopping operation of the bank note processing apparatus when a counterfeit bank note is detected or providing an audible signal.

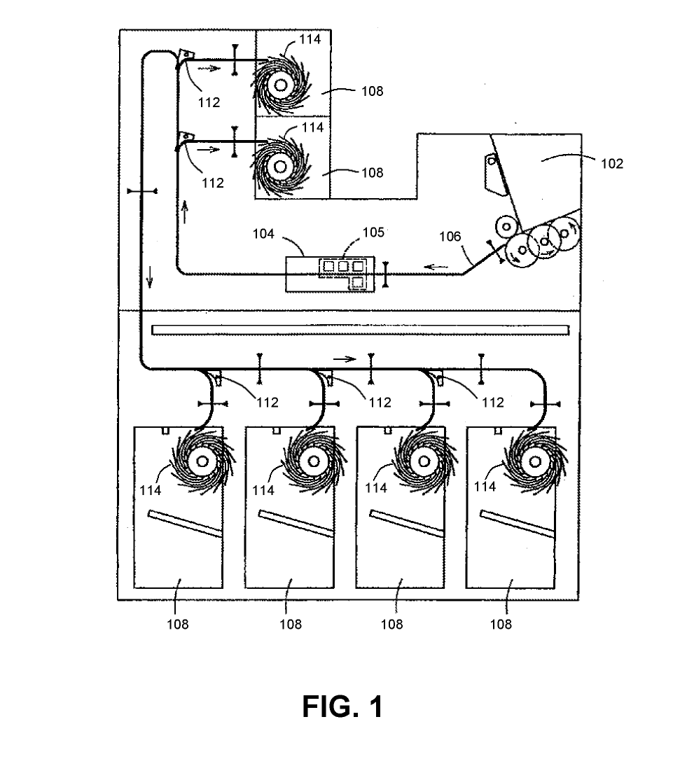

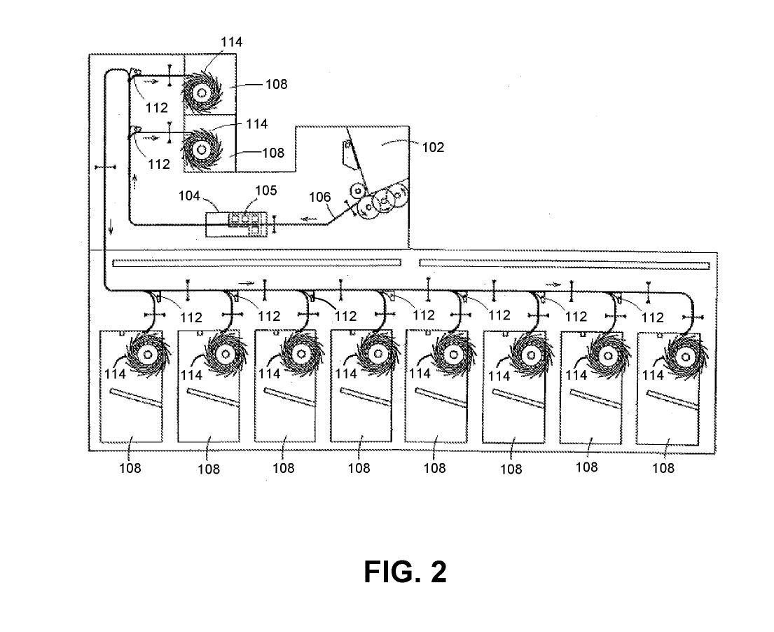

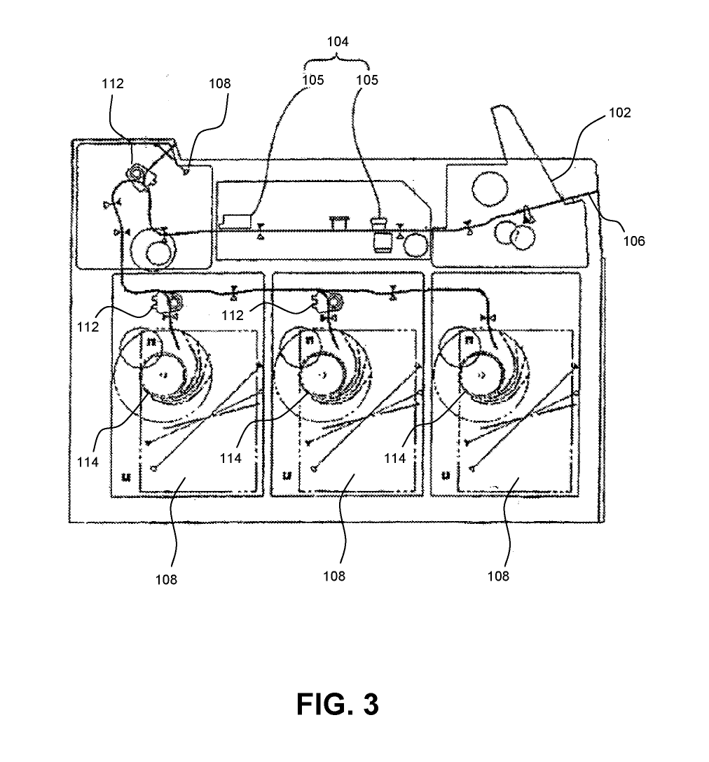

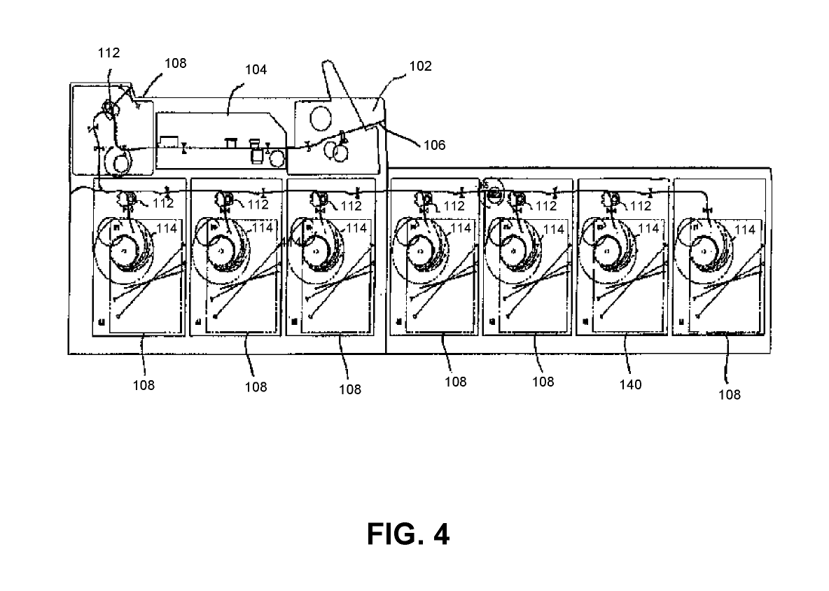

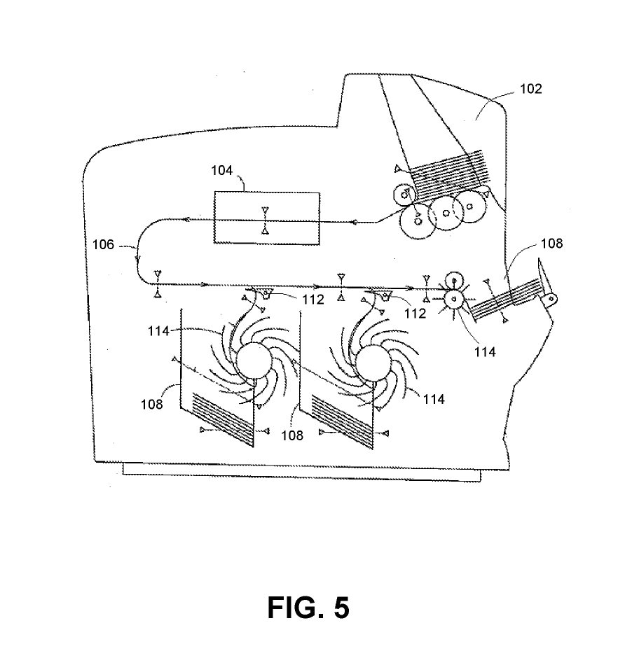

FIGS. 1-6 illustrate exemplary bank note processing apparatuses for carrying out a method of sorting bank notes. The bank note processing apparatuses are described for exemplary purposes, and the methods and systems disclosed hereinafter are not intended to be limited to the disclosed example bank note processing apparatuses. For example, the bank note processing apparatus may be of the type shown in U.S. Pat. Nos. 6,771,180 and 7,040,476, which may be adapted for use with the methods disclosed herein.

The bank note processing apparatuses preferably have a compact form factor; and preferably, the bank note processing apparatuses may be of desktop size.

As is known, the dimensions of a U.S. bank note are about 2.5 inches×6 inches (6.5 cm×15.5 cm). All U.S. bank notes have the same dimensions, but in many foreign countries, the dimensions may vary from one denomination to another. The bank note processing apparatuses may be adapted to process documents having the same dimension or documents having varied dimensions.

Referring to FIGS. 1-6, a bank note processing apparatus or system includes an input receptacle 102, an identification unit 104, a transport mechanism 106, and two or more output stacker units 108. Various transport mechanisms can be used to move bills through the apparatus such as conveyers, flexible blades, vacuum, etc. Transport of bills can be in the narrow direction or wide direction.

The input receptacle 102 is generally a hopper in which a bundle of bank notes is received for input into the bank note processing apparatus. The input receptacle 102 can also be configured to accommodate or be used directly with a change drawer from a POS.

The identification unit 104 is interposed between the input receptacle 102 and the stacker units 108 along the transport path 106. One or more sensors 105 are disposed in the identification unit 104 to detect one or more predetermined characteristics on a bank note conveyed through the identification unit 104. The sensors 105 may be configured to identify characteristics of the face-side and/or the back-side of a bank note. The sensors 105 may include double-sided detectors configured to simultaneously identify the face-side and back-side of a bank note.

Sorting plates 112 are disposed at points along the transport path 106 corresponding to each stacker unit 108, and the transport path 106 branches off at each sorting plate 112 to extend toward the respective stacker units 108. The sorting plates 112 serve to discharge the bank notes toward the stacker units 108.

The bank note processing apparatus can include one or more stacker units 108, which are receptacles into which the bank notes are received after sorting. The stacker units 108 may include bladed wheels 114 for aligning and stacking the bank notes discharged from the transport path 106. The stacker units 108 (or other mechanisms in the bank note processing apparatus) can be configured to bind or strap the bank notes. The stacker units 108 can also be configured to either accommodate or be used directly with a change drawer from a POS.

The stacker units 108 may be located adjacent to each other along a portion of the transport path 106. However, one or more stacker units may also be separated away from the other output stacker units 108. For example, one or more stacker units 108 may be located toward the front end of the transport path 106 at the upper portion of the bank note processing apparatus, while one or more stacker units 108 are located toward the rear end of the transport path at the lower portion of the bank note processing apparatus.

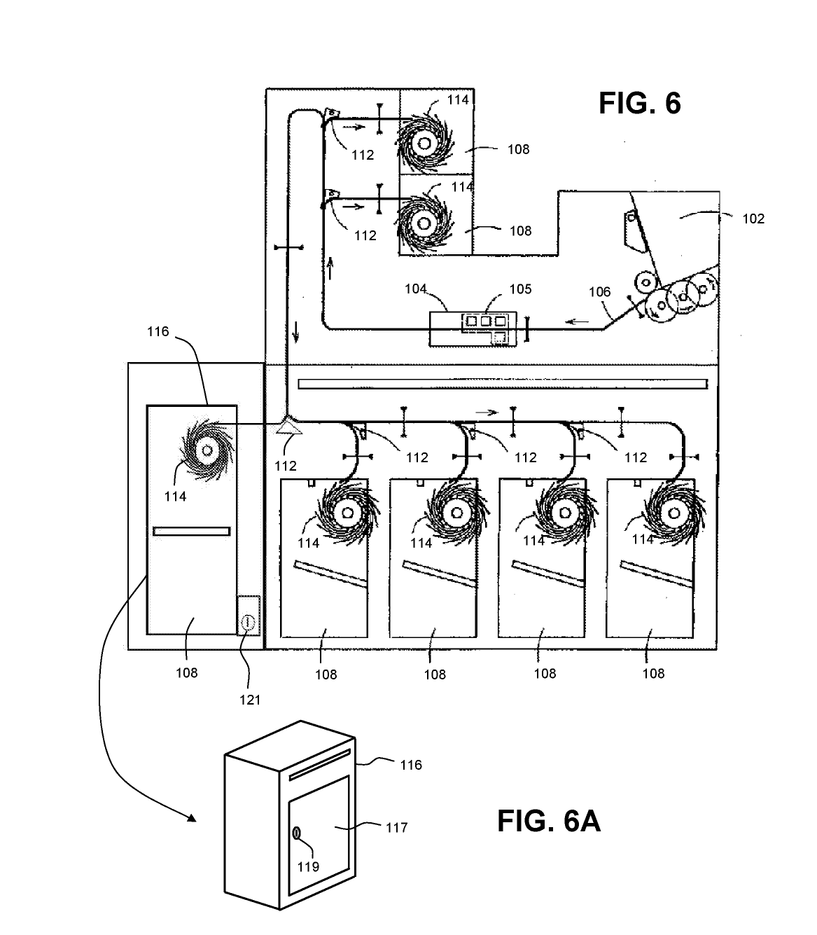

A secure cash box 116 may be connected to or incorporated in the bank note processing apparatus to receive bank notes (see FIG. 6). A sorting plate 112 discharges bank notes from the transport path 106 into a stacker unit 108 located within the cash box 116. The cash box 116 may include a bladed wheel 114 to align and stack the bank notes discharged from the transport path 106 and a mechanism to bind or strap the bank notes. The cash box 116 is preferably detachable from the bank note processing apparatus so that the bank notes contained therein can be transported securely. During operation, the cash box 116 is locked to the bank note processing apparatus by key lock 121 so that only authorized users can remove and transport the cash box. FIG. 6A illustrates the cash box 116 when removed from the bank note processing apparatus. The cover 117 of the cash box 116 is locked by key lock 119 so that only authorized users can access the bank notes stacked therein. Thus, a secure system for sorting and transporting bank notes may be provided.

In accordance with the present invention, any of the stacker units 108 may be configured to receive bank notes corresponding to a change fund, bank notes corresponding to sales proceeds, and/or rejects, if any. For example, one or more stacker units 108 located at the lower portion bank note processing apparatus may be configured to receive bank notes corresponding to the sales proceeds, while one or more stacker units 108 at the upper portion of the bank note processing apparatus may be configured to receive rejects or bank notes corresponding to a change fund.

Processing speeds for counting and sorting bills can be as fast as microprocessors and transport mechanisms allow. Of course, considerations such as cost, noise and the speed requirements of the particular environment can dictate using a speed lower than technology permits.

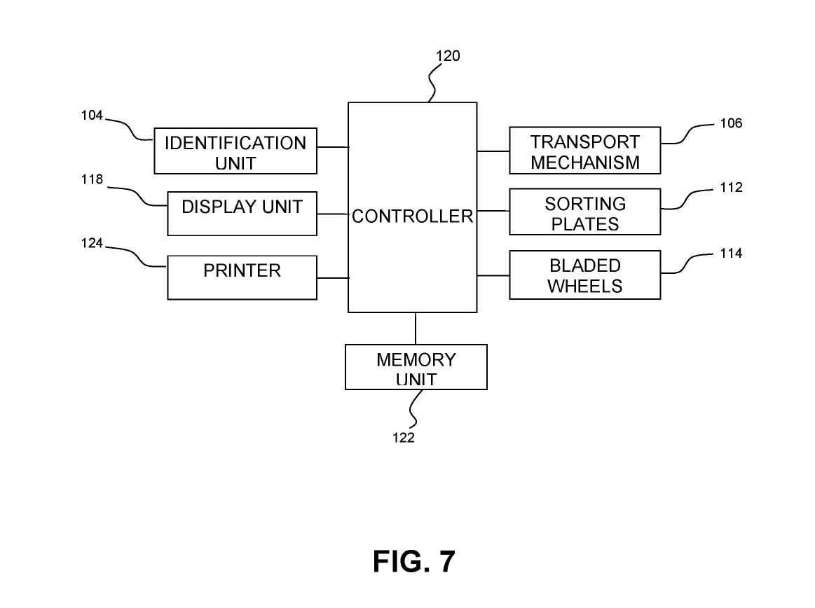

Turning to FIG. 7, the bank note processing apparatus includes display units 118. The display units 118 may be used to indicate the number or value of bank notes stacked in each stacker unit 108. The display units 118 may also be used to count down and indicate the number or value of bank notes required, as the sorting and stacking process proceeds, to reach a predetermined amount of bank notes that are to be stacked in each stacker unit 108. For example, the display units 118 may be LED displays, a monitor, or other electronic display means. The display units 118 may be located at each stacker unit 108 or be part of a centralized display unit. The display can be as simple or as complicated as a particular application requires. Further, a printer 124 may be included in or added to the system to print various kinds of reports.

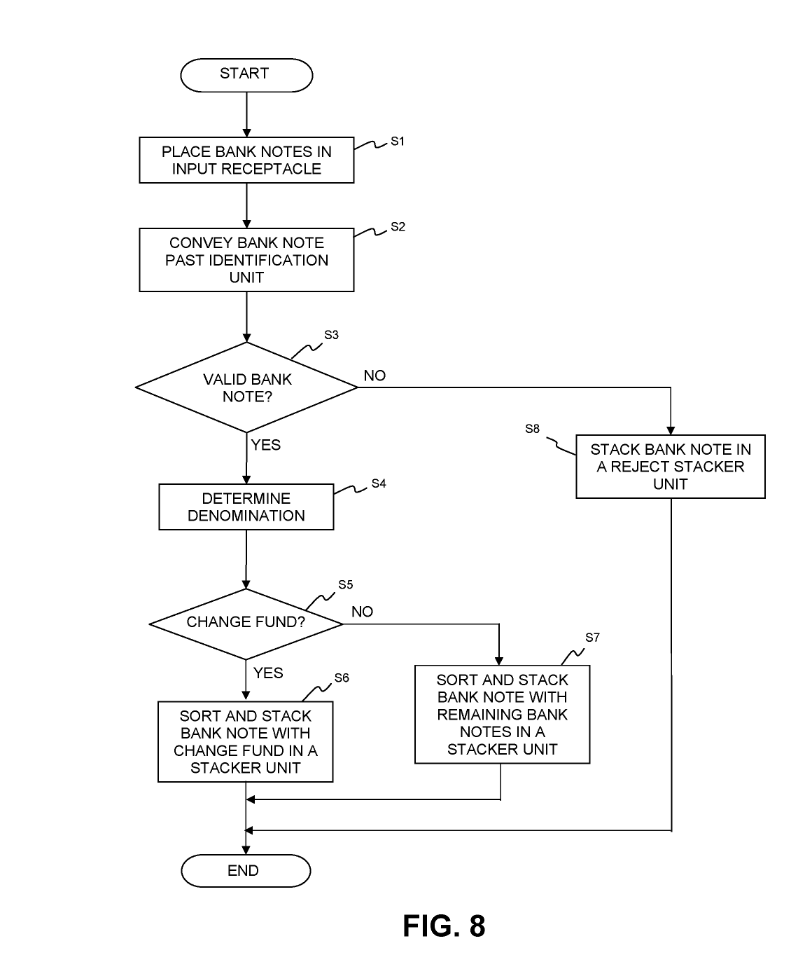

The bank note processing apparatus includes a controller 120 having one or more processors to control the operation of the bank note processing apparatus. For example, the controller 120 executes processing required for sorting and counting bank notes, executes signal processing, and controls various sensors, the identification unit 104, the transport mechanism 106, the sorting plates 112, the bladed wheels 114, the display units 118, and the like. To implement the various methods described herein, the controller 120 may be programmed with software and/or firmware to operate in accordance with the methods of FIGS. 8-10.

The bank note processing apparatus includes a memory unit 122 to store data. For example, the data may include information regarding the denominations to be processed, limits for the number of bank notes to be processed for each denomination, a limit for the total number or value of the bank notes to be processed, the number, denomination, and value of total bank notes counted and/or sorted, and the like. The memory unit 122 can store data for individual transactions and for multiple transactions. In accordance with the present invention, the monetary value, denominations, and number of bank notes to be included in a change fund can be pre-set or configured by an operator.

Depending on the environment of use, it may be desirable to add security levels that restrict certain operations to particular users. For example, it may be that only a supervisor should be able to change the amount of bank notes destined to be included in the change fund. Security features can be set using passwords, pin numbers, machine readable identification cards, or other types of access restricting methods

FIG. 8 is a flow chart showing a method for sorting bank notes according to one embodiment of the present invention. The method may implemented by software to instruct a bank note processing apparatus to count and sort bank notes, while separating out one or more change funds. The software may be stored in memory unit 122 and run by controller 120. For example, the method may be utilized in a retail environment to count and sort bank notes collected from a POS, and separate an amount equivalent to an initial change fund to be used to make change for a day's customer transactions.

Referring to FIG. 8, a stack of bank notes is inserted into an input receptacle of a bank note processing apparatus (step S1). The stack of bank notes can be in a mixed state or in a predetermined denomination order. The stack of bank notes can include bank notes only or the bank notes can be mixed with non-bank note documents. Operation may begin automatically when the bank notes are placed in the input receptacle, such as when a sensor detects the presence of the stack of bank notes, or manually, such as when the operator actuates a switch, key, or button on the bank note processing apparatus.

The bank notes are conveyed on a transport path through the bank note processing apparatus, one at a time, past the identification unit (step S2). The identification unit identifies whether each bank note is a valid bank note (step S3). If the bank note is a valid bank note, the identification unit identifies the denomination of the bank note (step S4), and it is determined whether the bank note should be included in a change fund or with the remaining bank notes (step S5). The bank note is sorted and stacked in a designated stacker unit for the change fund (step S6) or for the remaining bank notes (step S7). The bank note may also be sorted and stacked according to its denomination. If the bank note is not a valid bank note, the reject can be sent to and stacked in a designated stacker unit (step S8), such as a reject stacker unit, or the bank note processing apparatus can be stopped or paused so that the reject can be removed manually before restarting. The process continues until there are no further bank notes to be processed or until all of the predetermined limits of bank notes to be counted are reached.

Predetermined strap or bundle limits can be set for each of the stacker units. If the predetermined limits of bank notes for any or all of the stacker units is reached, the stacking of the bank notes to the specific stacker units or to all of the stacker units can be stopped or paused so that the bank notes can be removed. Once the bank notes are removed, the stacking of the bank notes to the specific stacker units or to all of the stacker units may be restarted.

The bank notes stacked in any of the stacker units may be bundled in groups of a predetermined number or value (e.g. 50 bank notes per bundled group or $100 per bundled group). The bundled groups of bank notes may be bound or strapped together, such as by wrapping a tape around the bundled bank notes.

In step S3, the identification unit detects one or more predetermined characteristics on a bank note conveyed through the identification unit. The predetermined identifying characteristic of the bank note is based on one of a number of variables. The variables relate to whether the bank note processing apparatus is authenticating, counting, or discriminating denominations of bank notes, and what distinguishing characteristics of the bank notes are being examined, for example, size, thickness, color, magnetism, optical reflectivity, absorption, transmissivity, electrical conductivity, serial number, and so forth. The identification unit may, for example, employ a variety of sensors including, but not limited to, any combination of the following: a size detector, a density sensor, an upper optical scan head, a lower optical scan head, a single or plurality of magnetic sensors, a thread sensor, an infrared sensor, an ultraviolet/fluorescent light scan head, or an image scanner.

Step S3 may include identifying whether the bank note is oriented as a face-side bank note or as a back-side bank note. If identification unit identifies the bank note as a valid face-side bank note, the method continues to step S4 in which the identification unit identifies the denomination of the bank note. However, if the bank note is not a valid face-side bank note, the identification unit also identifies whether the bank note is a valid back-side bank note. If the bank note is a valid back-side bank note, the method continues to step S4 in which the identification unit identifies the denomination of the bank note. If the bank note is not a valid back-side bank note or a valid front-side bank note, the method continues to step S8 and the reject is sent to and stacked in a reject stacker unit. Identifying whether the bank note is a face-side bank note and identifying whether the bank note is a back-side bank note may also be performed simultaneously or in reverse order.

In some embodiments, if a bank note is facing the wrong direction (e.g., face-side up or back-side up), the bank note may be transported to a bill facing unit before continuing to step S5 or S8. The bill facing unit may rotate the bank note to face the proper direction before sorting and/or transporting the bank note to a stacker unit.

Step S5 includes determining whether the bank note should be separated out and designated for a change fund. For example, a change fund may be destined for a cash drawer and used to make change for transactions at a point-of-sale (POS). However, the method of the present invention is not intended to be limited to separating out a change fund for use in a cash drawer, and may be used to separate out a group of bank notes that may be used for any number of other purposes.

The change fund includes a predetermined number or monetary value of bank notes of different denominations. The bank note processing apparatus can be configured so that a user can pre-select a total value for the change fund, the denominations of bank notes to be included in the change fund, and/or a given number or value of bank notes for each denomination. Alternatively, these determinations may be made based upon information received from the POS regarding sales revenue, refill transactions, transfer transactions, etc.

The predetermined number or value of bank notes to be separated out for the change fund can be equivalent to the total value for the change fund pre-selected by the user. For example, if a user pre-selects a total value for the change fund of $100, the value of the bank notes separated out for the change fund is $100.

However, the predetermined number or value of bank notes contained in the change fund may also be calculated from the difference between the total value for the change fund pre-selected by the user and a second input value. For example, if a user pre-selects a total value for a change fund of $100, but during a prior work shift a particular POS had a shortage of bank notes and $60 was transferred into the POS (e.g., refill transaction=$60), the calculated value of the bank notes separated out for the change fund will be $160. In another example, if a user pre-selects a total value for a change fund of $100, but during a prior work shift a particular POS had an excess supply of bank notes and $40 was transferred out of the POS (e.g., transfer transaction=$40), the calculated value of the bank notes separated out for the change fund will be $60.

Listed below are different embodiments for creating the change fund. The change fund can contain other combinations of bank notes and is not intended to be limited to the combinations listed below.

In one embodiment, the bank note processing apparatus may be configured to provide a change fund having a predetermined number of bank notes in each of a plurality of selected denominations (e.g., twenty $1 bank notes, six $5 bank notes, five $10 bank notes, and five $20 bank notes totaling $200). In another embodiment, the change fund can be configured to include a total value, wherein the bank notes in the change fund are distributed among the selected denominations according to the order in which the bank notes are input into the bank note processing apparatus (e.g., a distribution of bank notes of the selected denominations totaling or surpassing $100 which are distributed according to the order in which the bank notes are input into the bank note processing apparatus). In yet another embodiment, the change fund can be configured to include a total value, wherein the distribution of bank notes in the change fund includes at least a minimum number of bank notes in the selected denominations (e.g., a distribution of bank notes that totals or surpasses $100, wherein each of the denominations selected for the distribution includes at least one bank note).

The bank note processing apparatus determines whether the predetermined total number or value of bank notes for the change fund has been reached or surpassed. If the predetermined total number or value of bank notes have not been reached or surpassed, the bank note may be stacked in a stacker unit designated for the change fund (step S6). If the predetermined total number or value of bank notes for the change fund has been reached or surpassed, the bank note may be stacked in a stacker unit designated for the remaining bank notes (step S7).

When the denominations of bank notes included in the change fund are pre-selected, the bank note processing apparatus also determines whether the bank note is one of the selected denominations. If the bank note has a denomination matching one of the selected denominations and the predetermined total number or value of bank notes has not been reached or surpassed, the bank note may be stacked in a stacker unit designated for the change fund (step S6). If the bank note is not one of the selected denominations and/or the predetermined total number or value of bank notes has been reached or surpassed, the bank note may be stacked in a stacker unit designated for the remaining bank notes (step S7).

When the number or value of bank notes of the selected denominations included in the change fund are predetermined, the bank note processing apparatus also determines whether the predetermined number or value of bank notes in the selected denominations have been reached or surpassed. If the bank note has a denomination matching one of the selected denominations, the predetermined number or value of bank notes for that selected denomination of bank notes has not been reached or surpassed, and the predetermined total number or value of bank notes has not been reached or surpassed, the bank note may be stacked in a stacker unit designated for the change fund (step S6). If the bank note is not one of the selected denominations, the predetermined number or value of bank notes for that denomination has been reached or surpassed, and/or the predetermined total number or value of bank notes has been reached or surpassed, the bank note may be stacked in a stacker unit designated for the remaining bank notes (step S7).

In step S6, bank notes that will make up the change fund are separated out from the other bank notes and may either be stacked into one stacker unit or sorted into a plurality of stacker units. When bank notes of the change fund are stacked in one stacker unit, the change fund can be stacked in a mixed state or can be sorted by denomination. When bank notes of the change fund are sorted into a plurality of stacker units, the bank notes in the change fund can be sorted by denomination before the bank notes are stacked. The stacker units designated to receive the change fund may be any available stacker unit, including output stacker units and/or reject stacker units.

When sorted by denomination, each specified denomination may be stacked in a separate stacker unit, or two or more specified denominations may be stacked in the same stacker unit. If two or more denominations are stacked in the same stacker unit, the different denominations may be stacked in an offset manner (e.g., bank notes of a denomination being offset laterally from bank notes of another denomination) or may be separated by insertion of a slip sheet, using mechanical arrangements known in the art.

When the denominations of the bank notes in the change fund are predetermined, any of the bank notes that are not one of the specified denominations may be stacked either in a stacker unit with the remaining bank notes that are not part of the change fund, in a separate stacker unit, or in a reject stacker unit. Further, when the number or value of bank notes of a specified denomination in the change fund is predetermined, and the number or value of bank notes of the specified denomination in the change fund reaches the predetermined number or value, any further bank notes of that specified denomination may be stacked in a stacker unit with the remaining bank notes, in a separate stacker unit, or in a reject stacker unit.

One or more change funds may be separated out from the remainder of the bank notes. For example, one change fund may be separated out if the stack of bank notes includes bank notes collected only from a single POS, but multiple change funds may be separated out, for example if the stack of bank notes includes bank notes collected from multiple POS's.

If more than one change fund is to be separated out, the change funds may each be stacked in separate stacker units, or two or more change funds may be stacked in the same stacker unit. If two or more change funds are stacked in the same stacker unit, the different change funds may be stacked in an offset manner or may be separated by insertion of a slip sheet, using mechanical arrangements known in the art.

Each change fund may be separated out sequentially, wherein steps S5 and S6 are repeated together a number of times in series before proceeding to step S7. For example, when the bank notes stacked in a first change fund reaches a predetermined number or value, the stacking of the first change fund to a stacker unit is stopped, and the stacking of a second change fund a stacker unit is initiated.

The change funds may also be separated out concurrently. For example, change funds can be stacked into their respective stacker units, wherein steps S5 and S6 are repeated together a number of times in parallel before proceeding to step S7. Alternatively, the predetermined number or value of bank notes in the change fund can increased by the number of change funds to be separated out (e.g., $100 per change fund×5 change funds=$500).

In step S7, the remaining bank notes may either be stacked into one stacker unit or sorted into a plurality of stacker units. When the remaining bank notes are stacked in one stacker unit, the remaining bank notes can be stacked in a mixed state or can be sorted by denomination. When the remaining bank notes are sorted into a plurality of stacker units, the remaining bank notes may be sorted by denomination before the bank notes are stacked. Any available stacker unit may be designated to receive the remaining bank notes, including output stacker units and/or reject stacker units.

When sorted by denomination, each specified denomination of the remaining bank notes may be stacked in a separate stacker unit, or two or more specified denominations may be stacked in the same stacker unit. The remaining bank notes may be stacked in the same stacker units as the change fund or in different stacker units. If the remaining bank notes are stacked in the same stacker units as the change fund, the change fund and the remaining bank notes may be stacked in an offset manner or may be separated by insertion of a slip sheet, using mechanical arrangements known in the art.

If the denominations of the remaining bank notes are predetermined, any of the remaining bank notes that are not of one of the specified denominations may be stacked in separate output stacker unit or in a reject stacker unit.

Information associated with the processed bank notes can be displayed at any time throughout the process or at the end of the process. The information can be displayed on display units on the bank note processing apparatus or on a display connected to the bank note processing apparatus. The display can be as complicated or simple as the accounting needs for a particular location require.

The information can include the number, denomination, and/or monetary value of bank notes stacked in the bank note processing apparatus (e.g., three rejects, five $1's, seven $5's, three $10's, etc. or $200). For example, the information can specify the number, denomination, and/or monetary value the bank notes in each stacker unit, the bank notes in the change fund, the remaining amount of bank notes, and/or the overall amount of bank notes. The value of the display may be initialized to zero or may be initialized to some other value, such as a value representing the number or the monetary value of a previous batch of bank notes that was processed by the bank note processing apparatus. After the bank note is identified as a valid bank note in step S3 and the denomination is determined in step S4 (or, after the document is sorted and stacked in a stacker unit in step S5), the amount of bank notes indicated by the display is appropriately incremented. For example, either the display amount is increased by one or the value indicated by the display is increased by the value of the bank note.

The information can also include the number or monetary value of bank notes remaining to be stacked in the bank note processing apparatus to reach a predetermined number or monetary value (e.g. for a change fund). For example, the information can include the number or monetary value of bank notes remaining to be stacked in each stacker unit, the total number and/or denomination of the bank notes remaining to be stacked, the total monetary value of bank notes remaining be stacked, or the like. The value of the display may be initialized to a number representing the total amount of bank notes remaining to be stacked. After the bank note is identified as a valid bank note in step S3 and the denomination is determined in step S4 (or, after the document is sorted and stacked in a stacker unit in step S5), the amount of bank notes indicated by the display is decreased. For example, either the display amount is decreased by one or the value indicated by the display is decreased by the value of the bank note. The display information can also include a reason or codes as to why the document was identified as a reject.

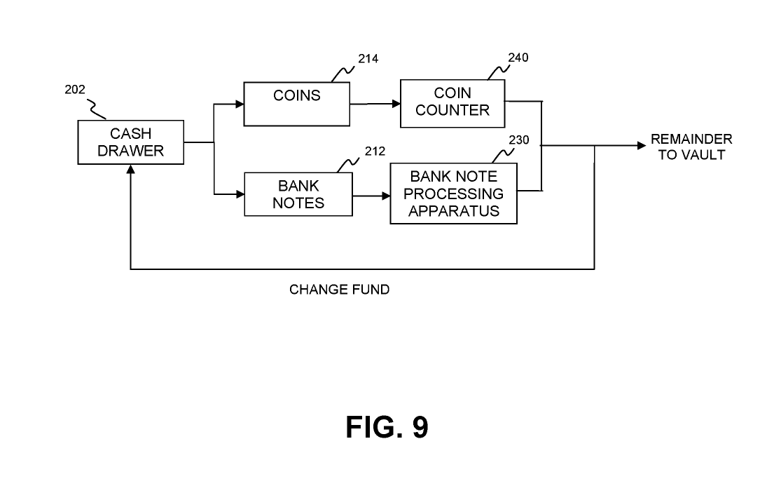

FIG. 9 is a block diagram/flow chart showing a system for providing a change fund according to one embodiment of the present invention. The system can be utilized in financial institutions to create a new change fund or funds (e.g., an operation fund) for use in a cash drawer to facilitate customer transactions. However, it is not intended that uses of the system be limited to financial institutions. For example, the system may be used in retail venues or a variety of other non-retail venues where cash is used for transactions or collection, such as in casinos, toll booths, and the like.

The system includes at least one cash drawer 202 and a bank note processing apparatus 230. The cash drawer 202 may be connected to a computer terminal (not shown) to record customer transactions, such as in a POS. An initial change fund that includes a given number of coins and bank notes may be included in each of the cash drawers 202 at the start of a time period, such as an employee's work shift or a business day. Bank notes 212 and coins 214 from transactions are subsequently collected in the cash drawer 202.

At the end of a time period, the bank notes 212 collected in the cash drawer 202 are removed and placed in an input receptacle of the bank note processing apparatus 230. The bank note processing apparatus 230 identifies, counts, sorts, and stacks the bank notes 212 as in the methods described above with reference to FIG. 8. The bank note processing apparatus 230 can be configured so that a user can pre-select a total value for the change fund, the denominations of bank notes to be included in the change fund, and/or a given number or value of bank notes for each denomination.

The coins 214 collected in the cash drawer 202 at the end of the time period are also counted. The coins 214 can be counted by a coin counter 240 or can be counted manually. For example, the coin counter 240 may be included in the bank note processing apparatus 230 or may be a stand-alone coin counting machine. The coin counter 240 may perform an equivalent function for coins that the bank note processing apparatus 230 performs for bank notes (i.e., count the coins and separate out a change fund of coins which may be used for the change fund).

The bank notes 212 and coins 214 separated out for the change fund are stored in a safe or vault for use in a cash drawer in another time period, such as the next employee's work shift or the next business day. The remainder of the bank notes 212 and coins 214 are stored separately in a safe or vault to be transferred to a central bank vault.

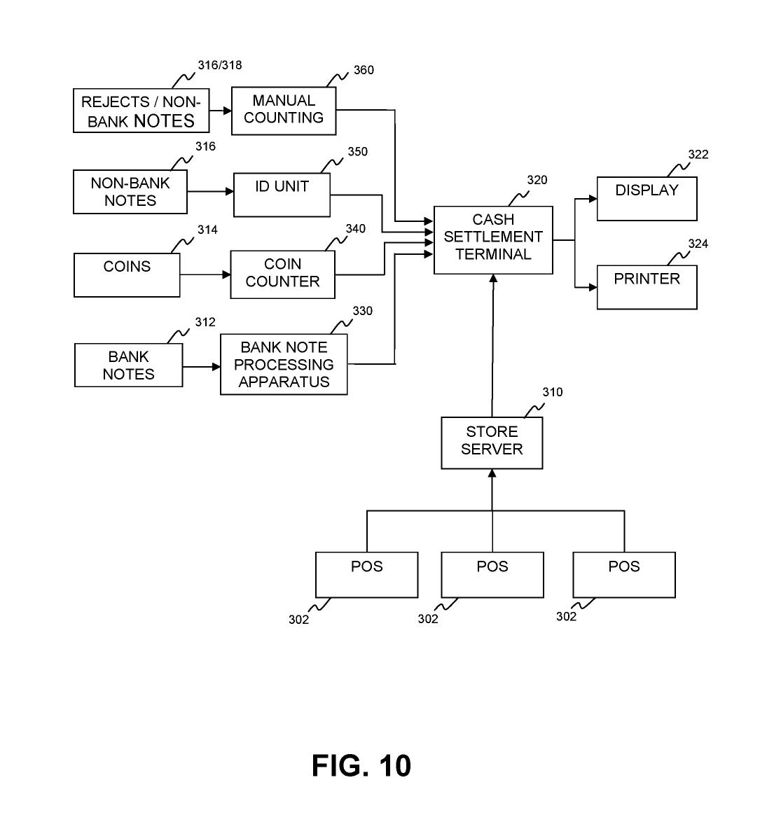

FIG. 10 is a block diagram/flow chart showing a system for managing revenue according to one embodiment of the present invention. The system can be used to create a new change fund or funds for use in a cash drawer of a point-of-sale (POS) for the next business day or next employee work shift. Additionally, the system can be used to verify whether the revenue earned from customer transactions balances with the proceeds collected by the POS.

The system can be utilized in retail venues, such as supermarkets, fast food restaurants, and the like. However, it is not intended that uses of the system be so limited. For example, the system may be used in a variety of non-retail venues where cash is used for purchases, transactions, or collection, such as in financial institutions, casinos, toll booths, and the like.

The system includes at least one POS 302, a store server 310, a cash settlement terminal 320, and a bank note processing apparatus 330 which are coupled together by a computer network. The system can be used to balance the revenue collected from a single POS 302, but may also be used to balance the revenue for a venue having multiple POS's 302.

An initial change fund that includes a given number of coins and bank notes may be included in each of the POS's 302 at the start of a time period, such as an employee's work shift or a business day, to make change for customer transactions. Bank notes 312, coins 314, and non-bank notes 316 (e.g., checks, coupons, food stamps, etc.) from transactions are subsequently collected in the POS 302.

Each POS 302 records data from the transactions and transmits the data over the network to the store server 310. This data in turn is transmitted from the store server 310 to the cash settlement terminal 320. For example, the recorded data may include the sales revenue (e.g., proceeds) and the change transaction amount (e.g., amount of money used in transactions to make change for customers) from the transactions that occurred at the POS 302 over a time period, such as a business day or an employee's work shift. The recorded data may include all of or only certain selected types of the transactions that occurred at the POS (e.g. currency transactions, credit card transactions, check transactions, and the like) over a time period. The recorded data can also include a record of when a particular POS 302 has a shortage of one or more denominations of bank notes.

At the end of a time period, the bank notes 312 collected in the POS 302 are removed and placed in an input receptacle of the bank note processing apparatus 330. The bank notes 312 may be separated from the non-bank notes 318 before being placed in the bank note processing apparatus 330 or the bank notes 312 may remain mixed with other non-bank note documents 318 when placed in the bank note processing apparatus 330. The bank note processing apparatus 330 identifies, counts, sorts, and stacks the bank notes 312 as in the methods described above with reference to FIG. 8.

The bank note processing apparatus 330 can be configured so that a user can pre-select a total value for the change fund, the denominations of bank notes to be included in the change fund, and/or a given number or value of bank notes for each denomination. However, the total number or value of bank notes in the change fund for a POS 302 and/or the number or value of bank notes of different denominations included in the change fund for a POS 302 can also be determined or dynamically adjusted according to information acquired from the POS 302.

For example, during a period of time (e.g., a single work shift, a single business day, or over multiple work shifts or business days), a POS 302 may experience a shortage or overage of the total number of bank notes or of the bank notes of a particular denomination. When a POS 302 has a shortage of bank notes of a specific denomination, the POS 302 may be refilled with a number of bank notes of that specific denomination (e.g., a refill transaction). When a POS 302 has an excess number of bank notes of a specific denomination, the excess bank notes of that specific denomination may be transferred out of the POS 302 (e.g., a transfer transaction). The POS 302 will record data from the refill and transfer transactions, which can then be utilized to identify a shortage or overage condition for a POS 302 and to adjust the total number or value of bank notes in the change fund or the number of bank notes for each denomination in the change fund. The adjustment will enable a venue to provide a change fund having an amount of bank notes of different denominations that better reflects the transactional needs of a particular POS 302.

Information related to the bank notes 312 that are counted by the bank note processing apparatus 330 is transmitted to the cash settlement terminal 320. For example, the bank note processing apparatus 330 can transmit the total value of the bank notes counted, the value of the bank notes in the change fund, and the value of the remaining bank notes (e.g., bank note proceeds). The bank note processing apparatus 330 can also transmit the number or value of bank notes in each stacker unit, the number of bank notes of each denomination, the number of rejects, the reason for the rejection, the value of any rejects that were identified, etc. The bank note information can be transmitted after the entire stack of bank notes has been processed or at any time between when each bank note is identified and after each bank note is sorted and stacked in a stacker unit.

The coins 314 collected in the POS 302 at the end of the time period are also counted. The coins 314 can be counted by a coin counter 340 or can be counted manually. For example, the coin counter 340 may be included in the bank note processing apparatus 330 or may be a stand-alone coin counting machine. The coin counter 340 may perform an equivalent function for coins that the bank note processing apparatus 330 performs for bank notes (i.e., count the coins and separate out a change fund of coins which may be used for the change fund).

Information related to the coins 314 that are counted can be transmitted to the cash settlement terminal 320 over the network or can be entered manually into the cash settlement terminal 320. For example, the information can include the total value of the coins 314 and the value of the coin proceeds. The coin proceeds may be calculated by subtracting the value of the coins in the initial change fund from the total value of the coins 314 collected in the POS. The value of the coin proceeds can be calculated by the cash settlement terminal 320, by the coin counter 340, or by hand.

The non-bank note documents 316 (e.g., checks, food stamps, coupons, and the like) collected in the POS 302 at the end of the time period, as well as any rejects 318 from the bank note processing apparatus 330, can be counted and entered into the cash settlement terminal 320. Non-bank note documents 316 and rejects 318 can be counted manually 352. However, if the non-bank documents 316 have some form of machine readable identification indicia (e.g., bar codes), the non-bank documents 316 can be scanned by an ID unit 350 (e.g., a bar code scanner). Non-bank documents 316 may be excluded if the system is capable of separating currency transactions from check transactions, food stamp transactions, coupon transactions, and the like.

The cash settlement terminal 320 calculates the difference between the sales revenue recorded at the POS 302 and the sales proceeds collected from the POS 302 (Difference=Sales Revenue−Sales Proceeds). The sales proceeds may be calculated by the exemplary algorithm included below. However, it is not intended that the present invention be limited thereto.

Sales Proceeds=Bank Note Proceeds+Coin Proceeds+Non-Bank Note Documents+Rejects

where:

Bank Note Proceeds=Total Bank Notes−Bank Notes in Initial Change Fund

Coin Proceeds=Total Coins−Coins in Initial Change Fund

Variations, derivations, and modifications of this algorithm are intended to be covered by this disclosure.

The cash settlement terminal 320 includes or is connected to a display 360 used to display the results of the calculation. The cash settlement terminal 320 may also include or be connected to a printer 324 used to print reports based on the results of the calculation. In the ordinary course, if transactions are performed without error, the sales proceeds should equal the total value of the bank notes, coins, and non-bank notes in the POS at the end of the day or work shift minus the initial change fund. In this event, the display 360 will indicate that there is no difference between the sales revenue and the sales proceeds. However, if there is a deficiency or overage in the sales proceeds, the display 360 will indicate the difference between the sales revenue and the sales proceeds.

Now that embodiments of the present invention have been shown and described in detail, various modifications and improvements thereon will become readily apparent to those skilled in the art. Accordingly, the spirit and scope of the present invention is to be construed broadly and limited only by the appended claims, and not by the foregoing specification.

What is claimed is:

1. A bank note processing apparatus comprising:
at least one input receptacle;
a transport mechanism configured to transport bank notes from the input receptacle in a one by one fashion along a transport path;
at least one bank note identification unit configured to identify the bank notes;
a plurality of stacker units into which the bank notes are received; and
a sorting mechanism configured to sort the bank notes into one of the plurality of stacker units according to the results of the identification,
wherein a cash box is detachably connected to an outside of the bank note processing apparatus, and
the transport mechanism transports the bank notes from the bank note processing apparatus into the cash box.

2. The bank note processing apparatus according to claim 1, further comprising:
a sorting plate configured to discharge the bank notes from the transport path into the cash box.

3. The bank note processing apparatus according to claim 1, wherein the cash box includes a bladed wheel to align and stack the bank notes discharged from the transport path.

4. The bank note processing apparatus according to claim 1, wherein the cash box includes a mechanism to bind or strap the bank notes.

5. The bank note processing apparatus according to claim 1, further comprising:
a mechanism to bind or strap the bank notes.

6. The bank note processing apparatus according to claim 1, wherein the cash box is locked to the bank note processing apparatus by key lock.

7. The bank note processing apparatus according to claim 1, wherein the cash box includes a cover which can be locked by key lock.

8. The bank note processing apparatus according to claim 1, wherein the stacker units are located adjacent to each other along a portion of the transport path.

9. The bank note processing apparatus according to claim 1, wherein one or more of the plurality of stacker units are located at a lower portion of the bank note processing apparatus, and one or more of the plurality of stacker units is located at an upper portion of the bank note processing apparatus.

10. The bank note processing apparatus according to claim 1, wherein the plurality of stacker units and the cash box are disposed side by side at a lower portion of the bank note processing apparatus.

11. The bank note processing apparatus according to claim 1, wherein the transport path includes an upper transport path from the input receptacle leading to a lower transport path, and the lower transport path leading to at least one of the stacker units which is disposed below the lower transport path.

12. The bank note processing apparatus according to claim 11, wherein the cash box is connected to the lower transport path.
